(19) United States
(12) Patent Application Publication
(10) Pub. No.: US 2012/0011129 A1
(43) Pub. Date: Jan. 12, 2012

(54) FACETED EXPLORATION OF MEDIA COLLECTIONS

(75) Inventors: Roelof van Zwol, Badalona (ES); Borkur Sigurbjornsson, Barcelona (ES); Kaushal Kurapati, San Jose, CA (US); Polly Ng, Hollis, NY (US); Anand Ramani, Bangalore (IN); Vanessa Murdock, Barcelona (ES); Sriram J. Sathish, Bangalore (IN); Anuj Sahai, Bangalore (IN); Mridul Muralidharan, Bangalore (IN); Lluis GarcÂa Pueyo, Sant Cugat del Vallas (ES)

(73) Assignee: Yahoo! Inc., Sunnyvale, CA (US)

(21) Appl. No.: 12/832,641

(22) Filed: Jul. 8, 2010

(51) Int. Cl. G06F 17/30

(52) U.S. Cl. 707/748; 707/E17.084; 707/E17.02

(57) ABSTRACT

Exemplary methods and apparatuses are disclosed that may be used to provide or otherwise support extraction of objects and facets from one or more extraction corpora and ranking of said facets using multiple ranking corpora.

### BACKGROUND

1. Field

A present disclosure relates to search engine information management systems and, more particularly, to search engine information management systems that extract objects and facets from external corpora and then ranks facets in response to a user-submitted query.

2. Information

With an enormous amount of information and documents being available and accessible over the Internet, search engine information management systems and information retrieval techniques continue to evolve and improve. A wide variety of data, such as, for example, text documents, image files, audio files, video files, or the like, is continuously being managed or otherwise located, retrieved, accumulated, stored, communicated, and analyzed. Various information databases with web as well as non-web content have become commonplace, as have related communication networks and computing resources that help users to access relevant information.

The Internet is widespread and omnipresent. The World Wide Web or simply the Web, provided by the Internet, is growing rapidly because of the large volume of information being added daily, if not hourly. In many instances, tools and services may be utilized to quickly identify and provide access to such information. For example, service providers may employ search engines to enable a user to search the Web using one or more search terms (e.g., a query), and to efficiently locate documents and/or files that may be of particular interest to that user. In addition to efficiently retrieving information, search engines may employ one or more functions or processes to rank retrieved documents or files, and to display such documents or files in an order that may be based on their relevance, usefulness, popularity, web traffic, recency, and/or some other measure.

Search engines may further arrange and present retrieved documents or files in a variety of different formats. Because of the very large amount and distributed nature of information on the Web, locating and presenting a desired portion of the information in an efficient manner is valuable for both users inexperienced at web searching and for advanced “web surfers.” Accordingly, it may be desirable to develop one or more methods, systems, and/or apparatuses that implement efficient information retrieval and presentation techniques for large networks, such as, for example, the Web, as well as for smaller networks or data repositories and personal computing devices.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating certain features and/or processes associated with an exemplary computing environment according to one implementation.

FIG. 2 is a schematic diagram further illustrating certain features and/or processes associated with an exemplary facet system according to one implementation.

FIG. 3 is a flow diagram illustrating an exemplary process for online serving of facets according to one implementation.

FIG. 4 is a flow diagram illustrating an exemplary process for ranking facets according to one implementation.

FIGS. 5, 6, and 7 are illustrative representations of screenshot views of a user display representative of search results according to exemplary implementations.

FIG. 8 is a schematic diagram illustrating an exemplary computing environment associated with one or more special purpose computing apparatuses and supportive of the processes illustrated in FIGS. 3 and 4.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to unnecessarily obscure claimed subject matter.

Some exemplary methods and apparatuses are disclosed herein that may be used to extract objects and facets from at least one external corpus, rank facets using at least one external corpus, and/or present ranked facets to a user in response to a user-submitted query.

As used herein, an “object” or “objects” may refer to a real-world entity or entities. Objects may include, but are not limited to, locations, people, and/or creative works. For example, objects may include countries such as Spain, Chile, the United Kingdom, and South Korea; cities such as London and New York City; celebrities such as Jennifer Aniston and Brad Pitt; and/or movies and television shows such as Fight Club and Friends.

An object may possess any number of associated attributes. For example, object attributes may include an object ID, which may comprise a unique alpha-numeric identifier for an object. Other object attributes may include, for example, one or more object names, one or more object aliases, one or more object types, one or more object subtypes, one or more object details, and/or one or more object sources. An object name may comprise a common name by which an object is known. An object alias may comprise an alternative name by which an object is known. An object type may comprise a high-level type associated with an object. An object subtype may comprise a fine-grained type associated with an object. An object detail may comprise an attribute-value mapping that may be used to store additional attributes of an object. An object source may comprise a location, such as an external corpus, where an object has been detected.

For purposes of illustrating specific examples of object attributes in greater detail, Table 1, which appears below this paragraph, presents several exemplary objects and exemplary attributes associated with such objects.

TABLE 1

| Attribute | Object 1 | Object 2 |
|---|---|---|
| ID | 14 | 17 |
| name | Bangalore, India | George Clooney |
| aliases | Bangalore, Bengaluru | George T. Clooney |
| type | location | person |
| subtypes | city | actor, director, celebrity |
| details | latitude = 12.9 . . . ; | date of birth = |
| | longitude = 77.5 . . . | May 6, 1961 |
| sources | GeoPlanet ™, Wikipedia | Yahoo! Movies, Yahoo! OMG |

As used herein, a “facet” may refer to a directed mapping from one object to another object. Similar to objects, a facet may also possess any number of associated attributes. For example, facet attributes may include a source object, a target object, and a facet type. A source object may comprise an object to which a facet belongs, a target object may comprise an object that represents a facet, and a facet type may comprise a type of an object relation. For purposes of illustrating specific examples of facet attributes in greater detail, Table 2, which appears below this paragraph, presents several exemplary facets and exemplary attributes associated with such facets.

TABLE 2

| Attribute | Facet 1 | Facet 2 |
|---|---|---|
| source object | Bangalore, India | George Clooney |
| target object | Cubbon Park | Ocean's Eleven |
| facet type | subsumes | played in |

As used herein, an “external corpus” or in the plural sense, “external corpora.” may refer to an organized collection or organized collections of any type of data accessible over the Internet and/or associated with an intranet, such as, for example, one or more web documents, web sites, databases, discussion forums or blogs, query logs, audio, video, image, or text files, and/or the like. In addition, an external corpus may comprise an open or fluid vocabulary, e.g., content of an external corpus may change over time. Optionally or alternatively, vocabulary of an external corpus may be static, e.g., may remain unchanged over time. Some exemplary implementations of methods and apparatuses disclosed herein may utilize more than one external corpus, and such external corpora may be separate or overlapping, and/or one corpus may be a subset of another. Finally, as will be seen, external corpora may be subdivided into one or more extraction corpora and one or more ranking corpora.

As used herein, an “extraction corpus” or “extraction corpora” may refer to one or more external corpora that are used to extract objects and facets. As used herein, a “ranking corpus” or “ranking corpora” may refer to one or more external corpora that are used to rank facets utilizing one or more measures, statistical or otherwise, derived from such ranking corpora. It should be appreciated that extraction and/or ranking corpora may or may not be separate or overlapping.

Vocabularies of external corpora may, although not necessarily, be organized around domain-specific targets and may include many object classes or types (e.g., cities, people, landmarks, locations, animals, jobs, holidays, etc.). In turn, an object type may have a very large number of subordinate or subsumed relations with other objects within a corpus. For example, in a large database (e.g., GeoPlanet™, Yahoo! Travel, etc.), a city (i.e., object type), such as London, may be related to a large number of other objects (e.g., Big Ben, London Eye, Tower Bridge, British Museum, Trafalgar Square, etc.) through a subsumed “city-landmarks” relation. In some implementations, such databases may be used as extraction corpora that may be separate from ranking corpora, and may be utilized to extract some or all facets, as mentioned above. In addition to subsumed relations, a particular object type may also have a very large number of suggestive associations and/or relations with other objects. As a way of illustration, Venice (i.e., object type “city”) may be associated with or related to a very large number of objects (e.g., museums, hotels, wine tasting, carnival, sightseeing, gondolas, graffiti, film festival, etc.) via a “location-event/activity” facet. As such, it may be advantageous to rank such facets to retrieve more relevant relations in response to a user query. It should be appreciated that these are merely examples of various objects and facets within one or more external corpora and that claimed subject matter is not limited to these examples.

As used herein, a “query” may refer to a search request including one or more key terms submitted to a search engine by a user to obtain desired information. As will be described in greater detail below, conceptually, a query may also be represented, for example, as an object class or type having subsumed and/or associational relations with a large number of objects in a vocabulary of at least one external corpus. As such, a query, thus, may have multiple aspects and/or concepts that may be advantageously utilized by a ranking function, as will be seen.

Following a above examples and taking into account, but not necessarily limiting to, such hierarchical nature of at least some associations between and/or among objects, an object such as “London” may be classified as a “source object,” and one or more objects related to such a source object through a subsumed relation (e.g., Big Ben, London Eye, Tower Bridge, British Museum, Trafalgar Square, etc.) may be classified as a “target object.” In a similar fashion, an object such as “Venice” may be classified as a “source object” suggestively associated with and/or related to multiple “target objects” (e.g., “museums,” “hotels,” “wine tasting,” “carnival,” “sightseeing,” “gondolas,” “graffiti,” “film festival,” etc.) within a vocabulary of one or more external corpora.

More specifically, as illustrated in exemplary implementations of a present disclosure, a query may be mapped to one or more facets associated with a vocabulary of at least one external corpus. In an implementation, such external corpora may represent ranking corpora, for example, and may be used to rank facets, as previously mentioned and as described below. For a particular source object, some or all relations with a sufficient degree of relevance (e.g., target objects) may be collected using a vocabulary so as to create a plurality of facets. Co-occurrence statistics of facets may be analyzed, and a probability of a particular target object co-occurring together with a particular source object in a corpus may be calculated. For a particular source object, then, target objects may be ranked using such probability of co-occurrence. Results of such ranking may be implemented for use with a search engine or other similar tools responsive to search queries.

Before describing some example methods, apparatuses, and articles of manufacture in greater detail, the sections below will first introduce certain aspects of an exemplary computing environment in which information searches may be performed. It should be appreciated, however, that techniques provided herein and claimed subject matter is not limited to these example implementations. For example, techniques provided herein may be adapted for use in a variety of information processing environments, such as, e.g., database applications, etc. In addition, any implementations or configurations described herein as “exemplary” are described herein for purposes of illustration and are not to be construed as preferred or desired over other implementations or configurations.

The World Wide Web, or simply the Web, may provide a vast array of information and may utilize hypermedia, such as HyperText Markup Language (HTML), to enable formatting and proper display of contents of a web document. A “web document,” as used herein, is to be interpreted broadly and may include one or more signals representing any source code, search result, file, and/or data that may be read by a special purpose computing apparatus during a search and that may be played and/or displayed to a user. As a way of illustration, web documents may include a web page, an e-mail, an Extensible Markup Language (XML) document, a media file, and the like, or any combinations thereof.

Considering the enormous amount of information available on the Web, it may be desirable to employ one or more search engines to help a user in locating and efficiently retrieving web documents of a particular interest. A search engine may determine relevance of a web document to a query based, for example, on an analysis of keywords, tags, text within such web document, and so forth. As used herein, “keywords” may refer to one or more words used in a title and/or a phrase within such document that may designate or otherwise suggest a content of such web document. “Tags” may refer to one or more identifying terms assigned to a web document and descriptive of such web document in a way that enables a user to locate a document again by filtering a collection of web documents associated with such one or more identifying terms.

Under some circumstances, it may also be desirable for a search engine to utilize one or more processes to rank web documents and to assist in presenting relevant and useful search results to a user. A search engine may employ one or more ranking functions, such as, for example, a ranking function based on a probability of co-occurrence derived from co-occurrence statistics of related objects in a vocabulary of at least one external corpus. A user, thus, may receive and view a web page including a set of search results listed in a particular order.

In some implementations, a displayed web page may include one or more segmented portions incorporating search results, and may provide an ergonomic and efficient interactive user environment. For example, one or more navigation tools or other interactive content associated with web documents, such as, for example, selectable tabs, hyperlinks, images, icons, etc., may be included in one or more segmented portions of the displayed web page in a manner allowing for selective interaction by a user. As a way of illustration, one segmented portion of a displayed web page may display a listing of target objects, and another segmented portion of a web page may display one or more web documents electronically associated with or otherwise grouped together with respect to a particular target object. A user, thus, may select a particular target object (e.g., Big Ben) from a ranked list within one portion of a page, and may browse through a number of web documents associated with Big Ben within another portion of a page without leaving original search results. This may save a user time and make navigating among web documents much easier. Of course, this is merely one possible example. Many forms of web page navigation may be employed.

A user, via a user interface, may access a particular web document by clicking on a hyperlink or other like tool associated with such document. As used herein, “click” or “clicking” may refer to a selection process made by any pointing device, such as, for example, a mouse, track ball, touch screen, keyboard, or any other type of device operatively enabled to select search results via a direct or indirect input from a user.

In some implementations, one or more dynamic searching techniques may be utilized to return a most current or “fresh” information in response to a query. Because of an enormous amount of data being added to the Web every day, maintaining an up-to-date index may be a challenging and expensive task. In some embodiments, a crawler may perform a new search and/or re-visit old content updating their index of web documents about once a month. Constraints, such as, for example, a size of the Web, a cost and finite nature of a bandwidth for conducting crawls, especially of deep Web resources, may contribute to slow network scan rates. As a result, query returns may be time-restrictive and may produce results that have been moved or deleted. As a way of illustration, use of a scalable search engine integration via a direct feed from one or more external corpora may help to return timely or “live” search results to a user's query including content deletions, additions, and/or modifications made in such corpora. Thus, unlike searching in which search results are obtained, indexed, and, therefore, ranked via a crawl, such dynamic searching and, therefore, ranking, may be performed at the time of a query. As such, ranking of search results may change in response to a submission of a query by a user.

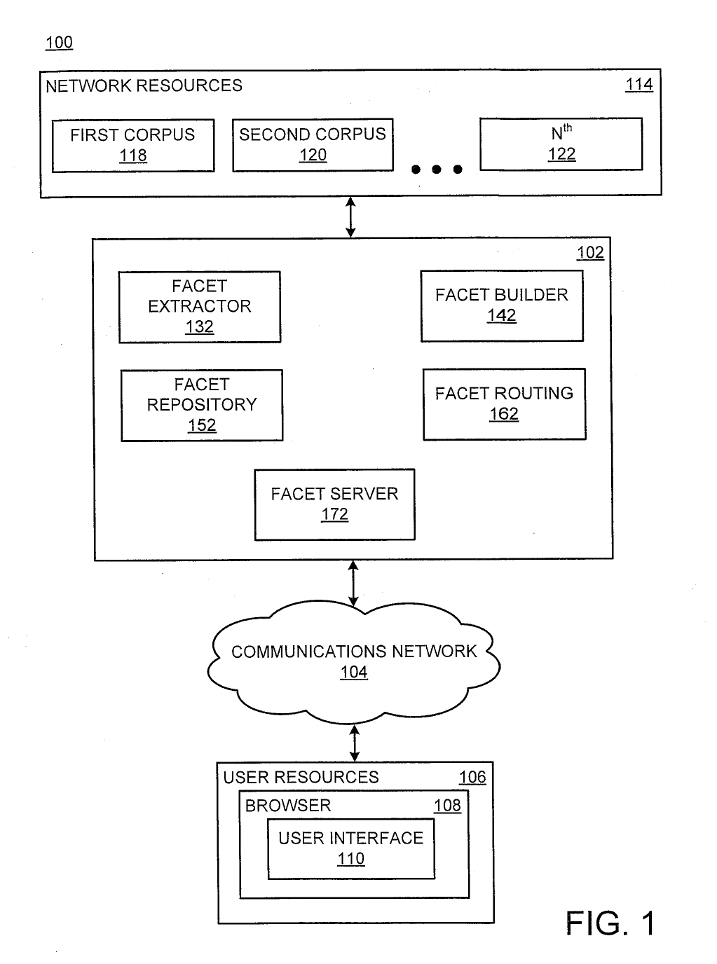

With this in mind, attention is now drawn to FIG. 1, which is a schematic diagram illustrating certain functional features and/or processes associated with an exemplary computing environment 100 that may be operatively enabled to perform ranking of facets associated with a vocabulary of at least one extraction corpus by utilizing a plurality of ranking corpora. Exemplary computing environment 100 may be operatively enabled using one or more special purpose computing apparatuses, data communication devices, data storage devices, computer-readable media, applications, and/or instructions, various electrical and/or electronic circuitry and components, input data, etc., as described herein with reference to particular exemplary implementations.

As illustrated in the present example, computing environment 100 may include a facet system 102 that may be operatively coupled to a communications network 104 that a user may employ in order to communicate with facet system 102 by utilizing user resources 106. It should be appreciated that facet system 102 may be implemented in a context of one or more search systems associated with public networks (e.g., the Internet, the WWW) private networks (e.g., intranets), for public and/or private search engines and websites, Real Simple Syndication (RSS) and/or Atom Syndication (Atom)-based applications and websites, and the like.

User resources 106 may comprise, for example, any kind of computing device, mobile device communicating or otherwise having access to the Internet over a wireless network (e.g., notepads, personal digital assistants, cellular phones, etc.), and the like. User resources 106 may include a browser 108 and a user interface 110 that may initiate a transmission of one or more electrical digital signals representing a query. Browser 108 may facilitate an access to and viewing of web pages over the Internet and may utilize HTML web pages as well as pages specifically formatted for mobile devices (e.g., WML, XHTML Mobile Profile, WAP 2.0, C-HTML, etc.). User interface 110 may comprise any appropriate input means (e.g., keyboard, mouse, touch screen, digitizing tablet, etc.) and output means (e.g., display, speakers, etc.) suitable for user interaction with user resources 106.

As previously mentioned, network resources 114 may include various corpora of information, such as, for example, a first corpus 118, a second corpus 120, and so forth up through a N^{th} corpus 122, any of which may include any organized collection of any type of data accessible over the Internet and/or associated with an intranet (e.g., web documents, web sites, databases, discussion forums or blogs, query logs, audio, video, image, or text files, and the like).

In an illustrated implementation, facet system 102 may include, but is not limited to, several functional modules such as a facet extractor 132, a facet builder 142, a facet repository 152, a facet ranker 162, and a facet server 172. More specifics regarding each of these functional modules are outlined in greater detail below.

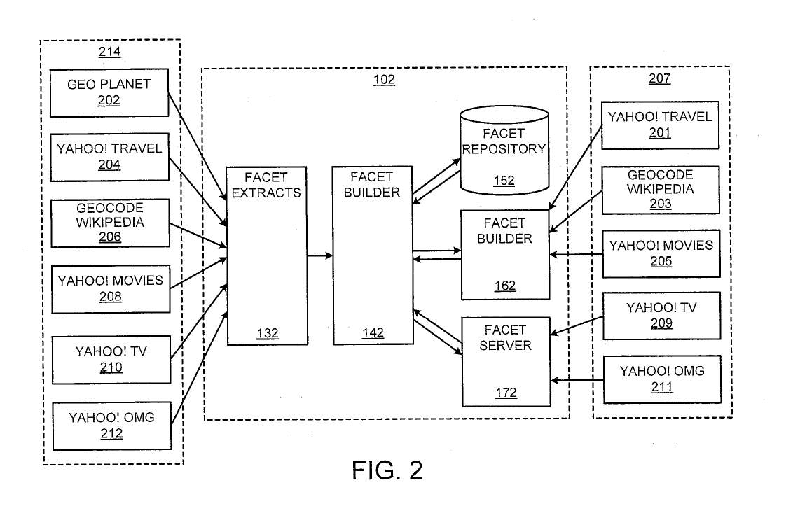

Reference is now made to FIG. 2, which is a schematic diagram further illustrating a system architecture that is associated with an exemplary facet system 102 according to one implementation. As mentioned above, according to an illustrated implementation a facet system 102 may include a facet extractor 132, a facet builder 142, a facet repository 152, a facet ranker 162, and a facet server 172. According to an exemplary implementation, a function of these named components of facet system 102 is as follows.

A facet extractor module 132 of facet system 102 may process incoming content from one or more extraction corpora 214 in order to extract objects and facets from such extraction corpora. While facet system 102 is general enough to handle any sort of data, in an illustrated implementation, extraction corpora 214 are chosen to include corpora that contain objects and facets related primarily to geographic and celebrity information. As illustrated, extraction corpora 214 may include GeoPlanet™ (extraction corpus 202), a resource for managing geo-permanent named places on Earth; Yahoo! Travel (extraction corpus 204), a comprehensive travel guide; geo-coded Wikipedia (extraction corpus 206), a collaboratively edited encyclopedia; Yahoo! Movies (extraction corpus 208), a movie information portal; Yahoo! TV (extraction corpus 210), a television information portal; and Yahoo! OMG (extraction corpus 212), a celebrity gossip and news site. Presently, Universal Resource Locators (URLs) for these particular corpora are http://developer.yahoo.com/geo/geoplanet/, http://travel.yahoo.com/, http://wikipedia.org/, http://movies.yahoo.com, http://tv.yahoo.com, and http://omg.yahoo.com, respectively.

According to the particular illustrated implementation, extraction corpora 214 may be semi-structured. As used herein, “semi-structured” may indicate that objects and facets existing in extraction corpora 214 may be explicitly marked with tags such that a facet extractor module 132 need not perform object recognition on content from extraction corpora 214. In other implementations, extraction corpora 214 may be unstructured and a facet extractor module 132 may perform object recognition in order to identify objects and facets from extraction corpora 214. Generally speaking, an extraction corpus in extraction corpora 214 may either be unstructured or semi-structured.

Table 3, which appears below this paragraph, presents an overview of exemplary object types and object subtypes that may be extracted from semi-structured extraction corpora 214 illustrated in FIG. 2. In the case of extraction corpus 206 (Wikipedia), a geo-coded article found in extraction corpus 206 may be considered to be an object.

TABLE 3

| Extraction Corpus | Object types | Object subtypes |
|---|---|---|
| 202 (GeoPlanet ™) | location | Countries, cities, states, lakes, |
| | | mountains, landmarks, etc. |
| 204 (Yahoo! Travel) | location | attractions |
| 206 (Wikipedia) | location | geo-coded Wikipedia pages |
| 208 (Yahoo! Movies) | person, | Actors, directors, and movies |
| | creative work | |
| 210 (Yahoo! TV) | person, | Actors, directors, and |
| | creative work | television shows |
| 212 (Yahoo! OMG) | person | celebrities |

Similar to Table 3, Table 4, which appears below this paragraph, presents an overview of exemplary facet types that may be extracted from semi-structured extraction corpora 214. In the case of extraction corpus 202 (GeoPlanet™), a built-in object hierarchy capability may be used to map between places (such as countries, states, cities, etc.) and points of interest (such as mountains, lakes, landmarks, etc). For extraction corpora 204 (Yahoo! Travel) and 206 (Wikipedia), facet extractor module 152 may utilize associated latitude (lat) and/or longitude (long) tags to map an attraction from extraction corpus 204 or an article from extraction corpus 206 to countries, states, and cities from extraction corpus 202. For extraction corpus 208 (Yahoo! Movies) and 210 (Yahoo! TV), facets may already be specifically identified in an associated data structure, e.g., an associated data structure may be semi-structured. For extraction corpus 210 (Yahoo! OMG), celebrities may already be specifically identified in an associated data structure, but a facet may be added for each pair of celebrities that appear in the same news article.

TABLE 4

| Extraction Corpus | Facet | Facet type |
|---|---|---|
| 202 (GeoPlanet ™) | place → point of | subsumes |
| | interest | |
| 204 (Yahoo! Travel) | place → attraction | subsumes |
| 206 (Wikipedia) | place → geo-coded page | subsumes |
| 208 (Yahoo! Movies) | person → movie | played in |
| 208 (Yahoo! Movies) | movie → person | has cast |
| 208 (Yahoo! Movies) | person → person | co-acted with |
| 210 (Yahoo! TV) | person → television show | played in |
| 210 (Yahoo! TV) | television show → person | has cast |
| 210 (Yahoo! TV) | person → person | co-acted with |
| 212 (Yahoo! OMG) | person → person | appeared with |

According to exemplary implementations, facet extractor 132 may perform object and facet extraction whenever a new extraction corpus becomes available and/or whenever an existing extraction corpus is updated. For example, facet extractor 132 may perform object and facet extraction whenever a fresh data dump becomes available, and/or whenever new items become available through an RSS feed.

Having processed data from external corpora 214 to extract objects and facets, facet extractor 132 may then pass objects and facets to facet builder 142, which may be responsible for storing objects and facets in facet repository 152. Facet builder 142 may perform other functions as well, and these additional functions are described in greater detail below in conjunction with descriptions of facet repository 152, facet ranker 162, and facet server 172. As will be seen, facet builder 142 may manage communications between facet repository 152, facet ranker 162, and facet server 172.

Turning attention now to facet repository 152, it should be appreciated that facet extractor 132 may extract millions of objects and tens of millions of facets. As mentioned above, facet extractor 132 may pass extracted objects and facets to facet builder 142, which may be responsible for storing objects and facets in facet repository 152. Thus, facet repository 152 may manage a back-end data storage function of objects and facets for facet system 102. Specifics of particular data storage techniques that may be utilized by facet repository 152 are not critical to this disclosure and are not described in further detail here, but it will be appreciated that electronic binary digits representative of extracted objects and facets may not necessarily be stored in a common geographic location. In other words, facet repository 152 may include multiple specific data storage elements or memories distributed across geographically separate locations.

As mentioned above, facet repository 152 may contain millions of objects and tens of millions of facets. Many objects in facet repository 152 may provide source objects for hundreds of facets. An objective of facet system 102 may be to return a selected list of facets in response to a user-submitted query. Due to the sheer volume of facets available in facet repository 152, facet system 102 may perform facet ranking in response to a user-submitted query in order to serve a selected subset of facets to a user in decreasing order of relevance. According to exemplary implementations, in facet system 102 a ranking function may be performed by facet ranker 162 in a manner described below.

Referring to FIG. 2, a facet ranker module 162 may receive data from a plurality of ranking corpora 207. In an illustrated implementation, ranking corpora 207 include a Flickr® tag corpus 201, a query term corpus 203, and a query session corpus 205. In other implementations, facet ranker 162 may utilize data from a larger or smaller number of ranking corpora, or from different ranking corpora than the ones illustrated in FIG. 2. However, regardless of the particular corpora used the principles described herein remain the same.

According to the particular illustrated implementation, a ranking of available facets may be performed by facet ranker 162 based upon a statistical analysis of query term corpus 203, query session corpus 205, and Flickr® tag corpus 201. Query term corpus 203 and query session corpus 205 may be derived from a history of user-submitted searches submitted to an image search log, such as Yahoo! image search. Flickr® tag corpus 201 may comprise tags associated with public photos found in a Flickr® database and may be used to complement knowledge derived from query term corpus 203 and query session corpus 205.

Often, data found in one ranking corpus may be formatted differently than data from another ranking corpus. Thus, according to some exemplary implementations, before a statistical analysis of data from ranking corpus 201, ranking corpus 203, or ranking corpus 205 may be performed, facet ranker 162 may first encode data from ranking corpus 201, ranking corpus 203, and ranking corpus 205 into a common data format. As used herein, a “common data format” may refer to a data format that identifies, within a ranking corpus and independently of the particular ranking corpus that is used, one or more events, a user (or users) that are associated with the one or more events, a timestamp (or timestamps) of the one or more events, objects in the ranking corpus, and relationships between the objects. The common data format enables a uniform processing of the data, and allows for efficiently computing statistics from multiple (and possibly different) ranking corpora.

Encoding data from ranking corpora 207 into a common data format may enable the same statistical analysis to be applied to each corpus 201, 203, 205 of the ranking corpora 207. Once data from the ranking corpora 207 has been transformed using such a common data format, a set of statistical metrics may be derived from each ranking corpus 201, 203, 205 based on a co-occurrence analysis of objects within a given event. Co-occurrence analysis is described in greater detail below. First, however, an example of a common data format according to exemplary implementations and further explanation regarding analyses that may be performed on ranking corpora 207 are presented in the following paragraphs.

According to exemplary implementations, data fields of a common data format for ranking corpora 201, 203, 205 may take a form as illustrated in column 1 of Table 5. Column 2 of Table 5 illustrates specific examples of data that may be used to populate the data fields of column 1 in response to a particular image search query entered by a user. For the example illustrated by Table 5, the particular image search query used was “Cubbon park in Bangalore India.”

TABLE 5

| EventID | e1001 |
|---|---|
| UserID | u01 |
| TimeStamp | t1 |
| EventData | cubbon+park, {bangalore+india, bangalore, India} |
| ObjectEntry | 345, {21, 21, 16} |

Referring to Table 5 and FIG. 2, a datum in an EventID field of a common data format according to an exemplary implementation may be used as a unique identifier within a defined event space. For example, for Flickr® tag corpus 201, an event space may comprise a collection of public photographs, and an EventID datum may uniquely identify a photograph in such an event space. In a case of query term corpus 203, an EventID datum may identify a page view. For query session corpus 205, an EventID may identify a set of consecutive page views that occur within a specified time window. A datum in a UserID field of a common data format according to an exemplary implementation may uniquely identify a particular user. Typically, a datum in a UserID field may be a browser cookie or a user's anonymized account ID. A datum in a TimeStamp field of a common data format according to an exemplary implementation may register a start time of an event associated with an EventID. A datum in a TimeStamp field may be stored in a Unix time format. A datum in an EventData field of a common data format according to an exemplary implementation may describe objects that have been detected during an event. A datum in an ObjectEntry field of a common data format according to an exemplary implementation may comprise a single object reference such as, for example, the phrase “cubbon park.” This may occur, for example, if the phrase “Bangalore, India” is detected. Besides this phrase, there also may be objects in a facet repository that refer to individual terms such as “Bangalore” and “India.”

According to some exemplary implementations, query term analysis performed on query term corpus 203 provides one source for ranking facets. As mentioned above, query term corpus 203 may be derived from a history of user-submitted searches submitted to an image search log, such as Yahoo! image search. Since many objects existing in facet repository 152 may comprise multiple words or phrases (e.g., person's names, movie titles, place names), it may not be ideal to simply segment a user query based upon word boundaries.

Accordingly, a facet ranker 162 may detect objects in a query term corpus 203 using a more intelligent segmentation scheme, details of which are described below in conjunction with Table 6. Table 6 outlines processes for detecting one or more objects in multiple word user queries in accordance with exemplary implementations, using a particular example image search query that was presented above in conjunction with Table 5.

TABLE 6

| | |
|---|---|
| user query | Cubbon park in Bangalore India |
| tokenization | Cubbon+park+in+Bangalore+India |
| normalization | cubbon+park+in+bangalore+india |
| segmentation | [cubbon+park]+in+[bangalore+India] |
| object detection | cubbon+park, {bangalore+india/bangalore, India} |

Row 1 of Table 6 contains an example text string that may be entered by a user, which is representative of an image search query that may be found in a query term corpus 203. Row 2 of Table 6 is representative of a tokenization of an image search query based upon word boundaries. As used herein, “tokenization” may refer to a process of breaking up a stream of text into meaningful elements. Next, a Unicode NFD normalization may be applied to a character string of row 2 to obtain a character string found in row 3. A sliding window may then be applied to tokens in character string of row 3 to find object references in a query and to segment a query. A result of object detection is presented using a common format field (EventData) in row 5. Note that as a result of object detection, four object references were found {cubbon+park}, {bangalore+india}, {bangalore}, and {india}. In some implementations, a word “in” may be discarded if it does not match any objects in facet repository 152.

According to some exemplary implementations, a query session analysis performed on query session corpus 205 by facet ranker 162 may provide another source for ranking facets in facet repository 152. As mentioned above, like query term corpus 203, query session corpus 205 may also be derived from a history of user-submitted searches submitted to an image search log, such as Yahoo! image search. However, according to exemplary implementations an event space for query session corpus 205 may be a query session, which may be defined as a set of consecutive queries issued by a same user within a specified period of time, e.g., fifteen minutes.

For example, consider a user (UserID=u01) who first searches for “India,” then narrows a scope of an original query to “Bangalore, India,” and finally decides to search for “Cubbon park” within a fifteen minute time frame. Table 7, which appears below this paragraph, uses data fields of a common data format that was presented above in conjunction with Table 5 to summarize data that may be collected for the particular query session described above.

TABLE 7

| | |
|---|---|
| EventID | e9001 |
| UserID | u01 |
| TimeStamp | t2 |
| EventData | india, bangalore+india, cubbon+park |

According to some exemplary implementations, each query in a query session may be tokenized and normalized in the same manner as that described above for query term analysis (Table 6), but there may be no further segmentation of a query. According to some exemplary implementations, only whole queries may be matched against objects existing in object repository 152 when object detection is performed.

Due to an exploratory nature of an image search, a user may enter numerous queries during one query session. Additionally, an average number of queries that a user enters during a query session may exceed an average number of query terms. Furthermore, a user may search for several different related topics during one query session, which does not support a facet-based exploration of objects. For these reasons, according to some exemplary implementations, an outcome of an analysis of query session corpus 205 may be accorded less weight than an outcome of an analysis of query term corpus 203.

According to some exemplary implementations, a Flickr® tag analysis performed on Flickr® tag corpus 201 by facet ranker 162 may provide yet another source for ranking facets in a facet repository 152. A Flickr® tag analysis may be based on tags defined for a large set of about 250 million photos that are publicly available on Flickr®. According to some exemplary implementations, an event for Flickr® tag corpus 201 may be defined around tags that a user may use to annotate his or her photo.

For example, suppose a user has annotated a Flickr® photo with tags Cubbon park, Bangalore, India. According to some exemplary implementations, for each of these three tags, facet ranker 162 may perform the same tokenization and normalization processes that were performed for a query term corpus 203 and a query session corpus 205, as described above, while preserving tag boundaries as defined by a user. Table 8, which appears below this paragraph, uses data fields of a common data format that was presented above in conjunction with Table 5 to summarize a data that may be collected for a particular Flickr® tag analysis described above.

TABLE 8

| | |
|---|---|
| EventID | e8008 |
| UserID | u01 |
| TimeStamp | t3 |
| EventData | cubbon+park, bangalore, india |

After facet ranker 162 performs the analyses described above for Flickr® tag corpus 201, query term corpus 203, and query session corpus 205, facet ranker 162 may then perform a ranking of facets in facet repository 152 in order of decreasing relevance for each ranking corpora 207. That is, facets in facet repository 152 may be ranked in order of decreasing relevance based upon objects found in Flickr® tag corpus 201, based upon objects found in query term corpus 203, and based upon objects found in query session corpus 205. After a facet's individual ranking from each ranking corpora 207 is obtained, an overall ranking for the facet may be computed by using a linear combination of the facet's individual rankings.

In order to accomplish this, facet ranker 162 may first compute a list of possible co-occurring object pairs for each EventID in each corpus of ranking corpora 207. For purposes of this disclosure, two objects may be defined as a co-occurring object pair when both objects are associated with a same web document, and/or possess recognized associational attributes or some characteristic of mutual dependency.

For instance, returning to the example of Tables 5 and 6, a query term analysis of user query “Cubbon park in Bangalore India” (EventID=e1001) resulted in EventData=cubbon+park, {bangalore+india/bangalore, india}. Table 9, presented below, summarizes possible co-occurring object pairs for this event.

TABLE 9

| | |
|---|---|
| cubbon+park | bangalore+india |
| cubbon+park | bangalore |
| cubbon+park | india |
| bangalore | india |

Now, having calculated possible co-occurring object pairs for each event found in ranking corpora 207, facet ranker 162 may employ one or more ranking functions to rank a target object that is mapped to a particular source object—in other words, a facet. A ranking function may be based, for example, at least in part, on one or more measures of co-occurrence of source object—target object pairs. As a way of illustration, such measure of co-occurrence may comprise a probability of co-occurrence of related objects in a vocabulary of at least one external corpus.

As used herein, a “probability of co-occurrence” may refer to a quantitative evaluation of a likelihood that a particular source object will co-occur together with a particular target object in a vocabulary of at least one external corpus. In one particular implementation, a probability of co-occurrence may be estimated as a ratio of a number of actual co-occurrences of the objects to a number of possible co-occurrences of the same objects on a predefined scale (e.g., 50%, 80%, etc., on a scale of 100). Under some circumstances, a probability of co-occurrence may be estimated, at least in part, from a numerical score (e.g., on a predefined scale) that may be assigned to or otherwise determined with respect to a particular target object in relation to one or more other target objects.

According to a particular implementation, a probability of co-occurrence may be estimated, at least in part, by using subsets of conditional and/or non-conditional probabilities that, in turn, may be derived, at least in part, from one or more co-occurrence distribution tables, such as, for example, a co-occurrence matrix. In an implementation, a co-occurrence matrix may represent, at least in part, raw counts of co-occurrences and occurrences of source and target objects within a vocabulary of at least one external corpus (e.g., a number of times source and target objects co-occur in a corpus).

It should be appreciated that a co-occurrence matrix may or may not be symmetric. In symmetric co-occurrence matrices, if a source object co-occurs with a target object, a target object co-occurs with a source object equally often, or:

P(source,target)=P(target,source) (1)

where P(source, target) and P(target, source) represent respective joint probabilities of the objects (e.g., of seeing a target object given that a source object is located and vice versa).

Optionally or alternatively, a co-occurrence matrix may not be symmetric (e.g., relations across a conditional (e.g., vertical) bar is not symmetric), or:

P(source|target)≠P(target|source) (2)

It should be noted, however, that these are merely illustrative examples relating to co-occurrence matrices and that claimed subject matter is not limited in this regard.

One or more subsets of non-conditional probabilities may be represented, at least in part, by a number of users for which a source object-target object pair occurs in a vocabulary of at least one external corpus and/or by a number of web documents that associate a objects together divided by a total number of web documents in a corpus, for example. For one or more subsets of conditional statistics, a conditional probability of a source object given a target object, for example, may be determined, at least in part, by counting a single and a combinational co-occurrences of objects (e.g., from a co-occurrence matrix) and then dividing a number of web documents containing both (e.g., source and target) objects by a number of documents containing only target objects. As a way of illustration, a conditional probability of locating a source object given that a target object is located may be estimated as follows:

$$P ( source \vert target ) \approx \frac{P ( source , target )}{P ( target )} \qquad ( 3 )$$

Similarly, a conditional probability of locating a target object given that a source object is located may be estimated as:

$$P ( target \vert source ) \approx \frac{P ( target , source )}{P ( source )} \qquad ( 4 )$$

A ranking function, then, may utilize a subset(s) of conditional and/or non-conditional probabilities to calculate a probability of co-occurrence of source object-target object pairs in a vocabulary of at least one external corpus. By way of example but not limitation, one or more statistical functions may be employed to account for distribution of various conditional and/or non-conditional probabilities, such as, a median, a mean, a percentile of mean, a maximum, a number of instances, a ratio, a rate, a frequency, and/or the like or any combination thereof. As one example among many possible, a probability of co-occurrence may be represented as Pₛ and may be approximated as follows:

$${P}_{s} \approx \frac{\begin{matrix}P ( source \vert target ) + P ( target \vert source ) + \\ P ( source ) + P ( target )\end{matrix}}{4} \qquad ( 5 )$$

Finally, consider a variant of conditional probability that may be approximated as follows:

$$P ( target \vert source ) \approx \frac{\vert source ⋂ target \vert}{\vert source \vert} \qquad ( 6 )$$

According to some exemplary implementations, |source| as used in expression (6) may be defined as a number of users that have used a source object in an event, and |source∩target| as used in expression (6) may be defined as a number of users that have used both a source and target object in an event. Thus, according to expression (6), rather than counting a number of times that an object, or pair of objects, appears, exemplary implementations may count a number of distinct users that use an object or a pair of objects. This may lessen an impact that a single user may have on a probability score.

Alternative implementations may use other metrics besides conditional probabilities as discussed above. These metrics may include atomic metrics such as probability and entropy, symmetric metrics such as joint probability, point-wise mutual information (PMI), and cosine similarity, and/or asymmetric metrics such as reverse conditional probability and a reverse Kullback-Leibler (KL) divergence. Based on empirical evaluations, it has been determined that conditional probability as discussed above may perform the best across all three ranking corpora 207, followed closely by joint user probability and PMI metrics.

According to exemplary implementations, a facet ranker 162 may compute, based on at least one of the techniques described above, rankings for facets residing in facet repository 152 using each corpus of ranking corpora 207. Next, to compute an overall ranking of facets for a given object of interest, facet ranker 162 may map object references (EventData) derived from ranking corpora 207 to their corresponding object IDs for objects residing in facet repository 152. Table 10, presented below this paragraph, illustrates a consequence of this mapping.

TABLE 10

| Source | Target | Source | Target | P |
|---|---|---|---|---|
| object name | object name | object ID | object ID | (target/source) |
| bangalore | cubbon + | 21 | 345 | 0.0034 |
| | park | | | |
| bangalore + | cubbon + | 21 | 345 | 0.0016 |
| india | park | | | |
| . . . | . . . | . . . | . . . | . . . |
| india | bangalore | 16 | 21 | 0.064 |

Referring to Table 10, it is seen that while “bangalore” and “bangalore+india” refer to the same object (source ObjectID=21) in a facet repository 152, two facets are listed, each having different probabilities. This inconsistency may arise because in the real world, the same object may sometimes be referred to by different names. Conversely, different real world objects may sometimes be referred to using the same name. For example, the term “Rome” may be used to refer to a city in Italy or a city in the United States (Rome, N.Y.). In the first instance, an inconsistency may be solved by choosing a maximum probability as the facet score [e.g., P(345|21)ₘₐₓ=0.0034]. In the second instance, an inconsistency may be solved by sending a disambiguation request to a user (e.g., “Did you mean Rome, Italy or Rome, N.Y. ?”).

Finally, after a probability of co-occurrence has been computed for each facet in facet repository 152 for each ranking corpora 107, facet ranker 162 may compute an overall ranking for each facet using a linear combination of individual rankings from each ranking corpus. According to exemplary implementations, most weight may be given to a probability of co-occurrence derived from a query term corpus 203, followed by a probability of co-occurrence derived from a Flickr® tag corpus 201, and least weight given to a probability of co-occurrence derived from query session corpus 205. Query term analysis and Flickr® tag analysis may both be better at finding facets of a given object than query session analysis, which may be better at a more lateral search experience such as celebrities that share certain characteristics, but do not have a direct (faceted) relationship. Query term analysis may also be preferred over Flickr® tag analysis because the nature of image search tends to be broader than Flickr®. For instance, query term analysis may have a better coverage of celebrity and entertainment businesses.

According to exemplary implementations, facet ranker 162 may, upon activation, request a list of facets from facet builder 142, rank the facets according to at least one of the techniques described above, and return the ranked facets back to facet builder 142, which updates scores in facet repository 152.

Returning to FIG. 2, a description of exemplary aspects of facet server 172 will now be presented. According to exemplary implementations, facet server 172 is responsible for interaction with an application, which may, but not necessarily, comprise a search engine. Given a user query 209, facet server 172 may request from facet builder 142 a list of ranked facets 211 to be returned to a user. Preferably, serving of facets may be performed on demand when a user enters a query.

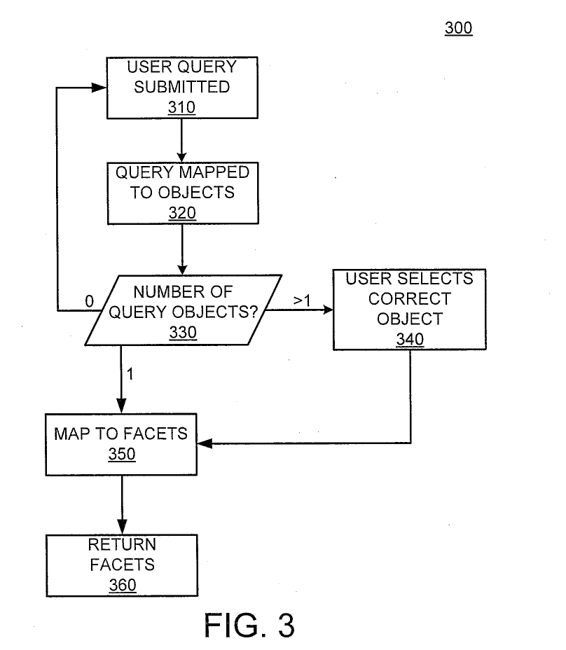

FIG. 3 is a flow diagram illustrating an exemplary process 300 for online serving of facets according to one implementation. Referring to FIG. 3, process 300 begins with subprocess 310, where a user query may be submitted via an image search application, such as Yahoo! image search. For example, a user may type a query into a search box and press return to send a query to a system such as facet system 102 illustrated in FIG. 2.

Next, at subprocess 320, after a user query is received by a facet system, according to exemplary implementations such a user query may be mapped to zero or more objects that exist in a facet repository of a facet system. One particular way to accomplish this is by matching a string that is representative of a user's query against an object's object name and/or against one of an object's alias names to return zero, one, or multiple query objects from a facet repository.

Next, at subprocess 330, a number of query objects that are returned based on a user query may determine a next stage of process 300. If no query objects are returned from facet repository, normal image search results may be shown and process 300 may return to subprocess 310 to await another user query. As used herein, “normal image search results” may refer to search results that do not identify facets within the search results.

If multiple query objects are returned from a facet repository, a user may be prompted to select from one of a multiple query objects at subprocess 340 to disambiguate the multiple results. As mentioned above, multiple query objects may be returned because different objects, and frequently locations in particular, are sometimes referred to using a same name. For example, both an object “Cambridge, UK” and an object “Cambridge, Mass.” may be returned if a user submitted a query that was simply “Cambridge.”

If a unique query object is returned from a facet repository in response to a user query, or if a user disambiguates from among multiple query objects at subprocess 340, process 300 may proceed to subprocess 350, where such query object may be mapped to a top-N set (e.g., top ten) of ranked facets that originate in a query object. That is, a query object may be a source object for each of a top-N set of ranked facets.

A returned facet object list may be processed in a decreasing relevance order and facets may be chosen for display if at least one of the following criteria is met. First, a facet may be chosen for display if there are a sufficient number of photos associated with such a facet to fill a result screen. A number of photos associated with a facet may be estimated by composing a query based on a concatenation of the names for a source object and a target object of a facet. Second, a facet may be chosen for display if a target object string for a facet is not a near duplicate of a previous target object string. In some cases, if numerous extraction corpora are used to populate a facet repository, the same object may be extracted from multiple sources, so two instances of the same object having identical or nearly identical names may exist in a facet repository. For example, one extraction corpus may refer to a famous New York City skyscraper as Empire State Building, while another extraction corpus may refer to a same structure simply as Empire State. In this situation a currently processed target object name may be checked to see if it overlaps with a previously processed target object name and if so, an associated facet may be selected if a currently processed target object name is longer than a previously processed target object name. After a selected number of ranked facets have been chosen for display the selected facets may be returned at subprocess 360.

In another aspect according to exemplary implementations, facets may be ranked according to visual characteristics of a set of images that are related to a query. For example, a query may be “New York at night.” According to an exemplary implementation, a concept detector module may determine a relevance of the returned facets for the query by detecting a ratio of night-time pictures in all “New York” pictures. Many other concept detector modules that are designed to identify other visual characteristics in a set of images may be contemplated. For example, other concept detector modules may include, but are not limited to, concept detector modules implemented for detecting beach pictures, portrait-style pictures, close-up style pictures, landscape pictures, black-and-white pictures, etc. These concept detectors may be considered a specialized ranking corpora, and in accordance with the teachings presented above may be added to a linear combination of ranking sources as another weighted component of an overall ranking. Concept detectors may also be combined with an existing overall ranking using some other alternative fusion technique.

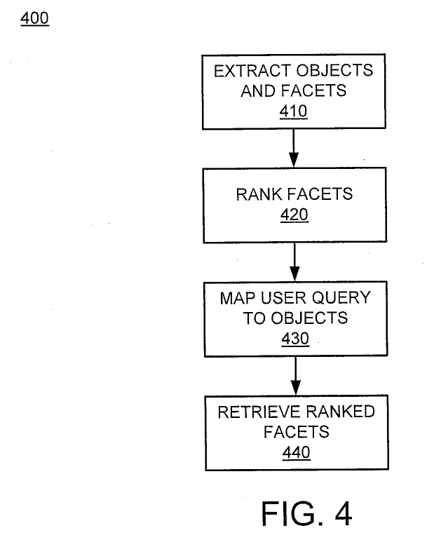

Having now described numerous functional capabilities of a facet system 102 according to exemplary implementations, it may be useful to briefly describe an exemplary process for ranking facets according to some embodiments. Accordingly, FIG. 4 is a flow diagram illustrating an exemplary process 400 for ranking facets according to one implementation.

Process 400 starts with subprocess 410, which may include extraction of multiple objects and facets from one or more extraction corpora using, for example, one or more of the techniques described above. Next, subprocess 420 may include ranking of extracted facets using multiple ranking corpora using, for example, one or more of the techniques described above. Once the facets are ranked, process 400 proceeds to subprocess 430, where a user query may be mapped to zero, one, or multiple query objects. As was explained above in conjunction with FIG. 3, it may be necessary for a user to disambiguate among multiple query objects. Once a unique query object has been identified, process 400 may proceed to subprocess 440, where a list of top-N ranked facets having a source object that matches said unique query object may be retrieved and displayed to the user on, for example, user resources 106 as illustrated in FIG. 1.

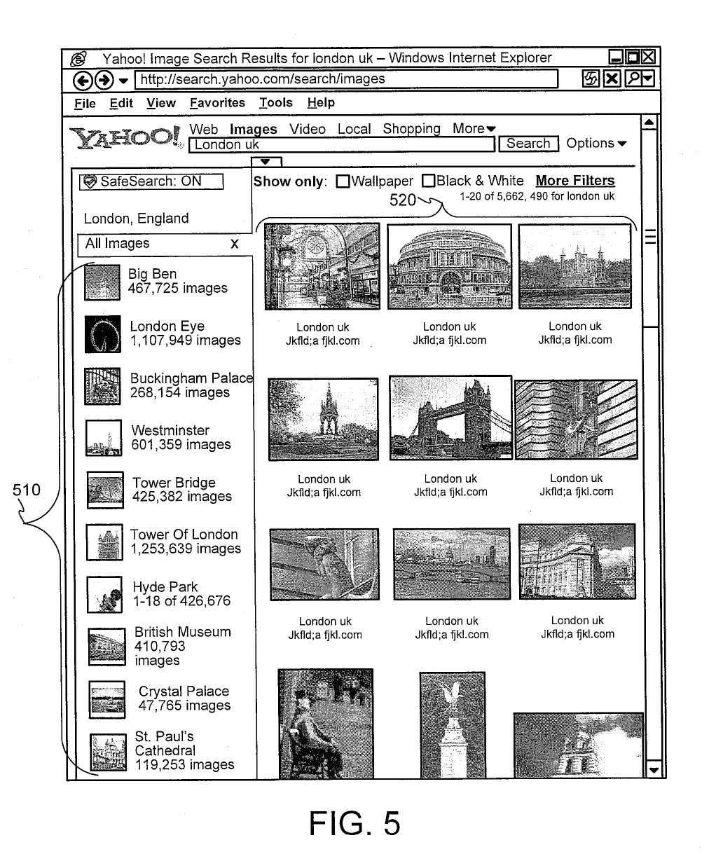

FIGS. 5, 6, and 7 are illustrative representations of screenshot views of a user display representative of search results according to exemplary implementations. In particular, FIG. 5 is a screen capture of a search result page resulting after a user submits an image search query for “London UK” to a facet server that operates in accordance with one or more of a principles that were described above. As shown, a ranked list of ten facets 510 may be displayed on a far left hand side of a user display and a substantial remainder of said display may be occupied by a set 520 of thumbnail images of Flickr® photographs having tags that match a submitted query.

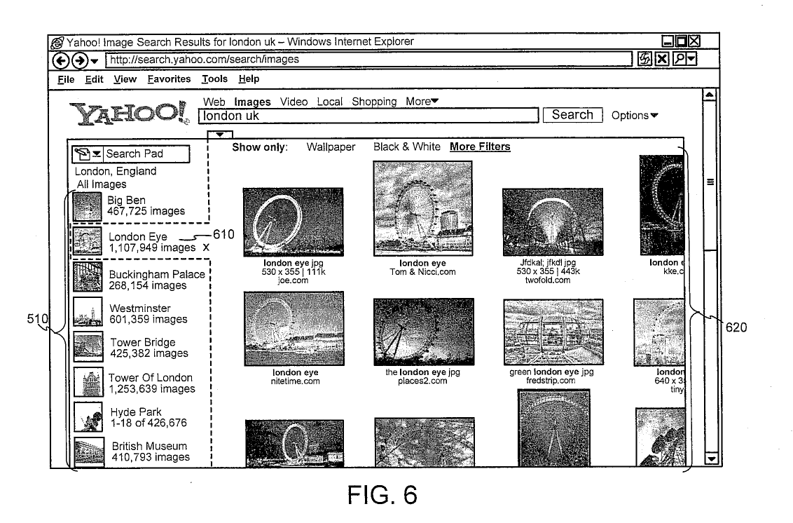

FIG. 6 is a screen capture of the same search result page from FIG. 5, but after a user has selected a London Eye facet 610 from among a ranked list of facets 510. As shown, in response to such a selection, exemplary implementations may replace set 520 of Flickr® photographs with a new set 620 of Flickr® photographs, new set 620 having tags that match London Eye facet 610.

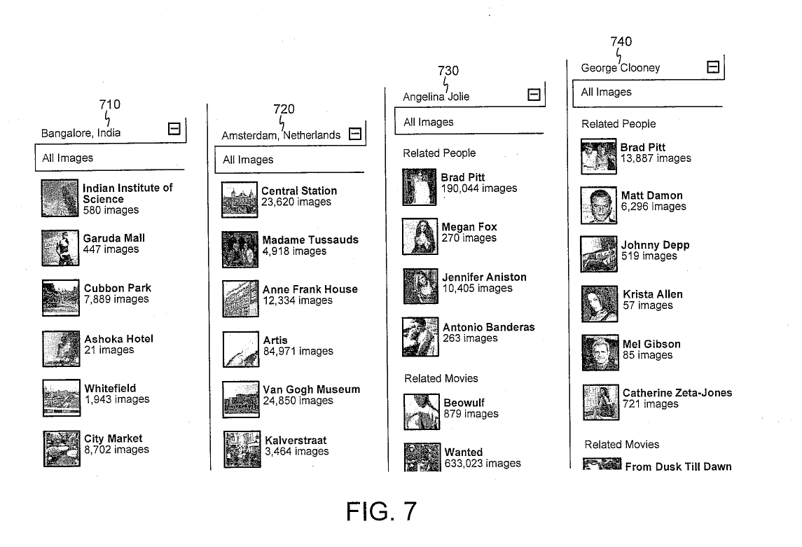

FIG. 7 is a representative display of four example facet lists that may be returned in response to a user submitting various image search queries to a facet server that operates in accordance with one or more of the principles that were described above. Facet list 710 is representative of ranked facets that may be returned in response to a query “Bangalore, India,” facet list 720 is representative of ranked facets that may be returned in response to a query “Amsterdam, Netherlands,” facet list 730 is representative of ranked facets that may be returned in response to a query “Angelina Jolie,” and facet list 740 is representative of ranked facets that may be returned in response to a query “George Clooney.”

For geographical queries, it should be noted that facet lists 710 and 720 may include target objects for facets that are all of the same type, e.g., location. In the case of celebrities, as shown by facet lists 730 and 740, a facet system may offer a variety of types. For example, for a given celebrity a retrieved facet list may contain other people related to a celebrity or movies that a celebrity appeared in. This information may be used by a facet system interface to further organize related facets. Facet lists 730 and 740 further illustrate that for a celebrity queries facet lists may be further subdivided into related people, related movies, and related television shows. This additional subdivision of facet lists in accordance with some exemplary implementations may help a user obtain a better overview of displayed facets.

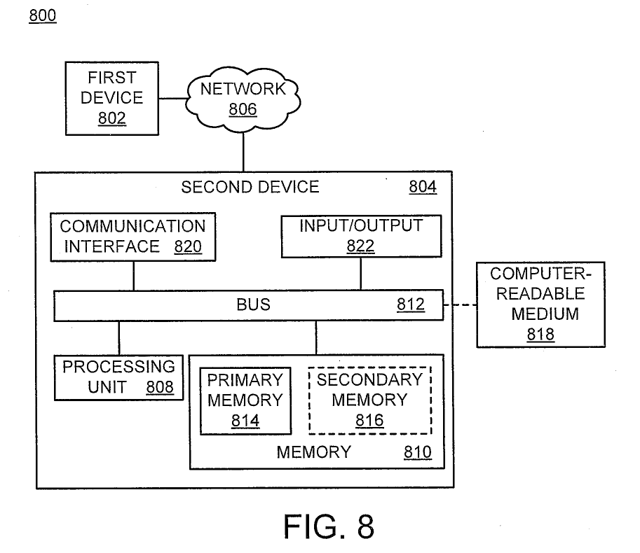

FIG. 8 is a schematic diagram illustrating an exemplary computing environment 800 that may include one or more devices that may be configurable to partially or substantially implement a process of ranking objects using one or more techniques described herein, such as, for example, ranking objects associated with a vocabulary of at least one external corpus using entity relations within a corpus.

Computing environment system 800 may include, for example, a first device 802 and a second device 804, which may be operatively coupled together via a network 806. Although not shown, optionally or alternatively, there may be additional like devices operatively coupled to network 806.

In an embodiment, first device 802 and second device 804 each may be representative of any electronic device, appliance, or machine that may be configurable to exchange data over network 806. For example, first device 802 and second device 804 each may include: one or more computing devices or platforms, such as, e.g., a desktop computer, a laptop computer, a workstation, a server device, data storage units, or the like.

Network 806 may represent one or more communication links, processes, and/or resources configurable to support an exchange of data between first device 802 and second device 804. By way of example but not limitation, network 806 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It should be appreciated that all or part of the various devices and networks shown in computing environment system 800, and the processes and methods as described herein, may be implemented using or otherwise include hardware, firmware, or any combination thereof along with software.

Thus, by way of example but not limitation, second device 804 may include at least one processing unit 808 that may be operatively coupled to a memory 810 through a bus 812. Processing unit 808 may represent one or more circuits configurable to perform at least a portion of a data computing procedure or process. As a way of illustration, processing unit 808 may include one or more processors, controllers, microprocessors, microcontrollers, application specific integrated circuits, digital signal processors, programmable logic devices, field programmable gate arrays, and the like, or any combination thereof.

Memory 810 may represent any data storage mechanism. For example, memory 810 may include a primary memory 814 and/or a secondary memory 816. Primary memory 814 may include, for example, a random access memory, read only memory, etc. While illustrated in this example as being separate from processing unit 808, it should be appreciated that all or part of primary memory 814 may be provided within or otherwise co-located/coupled with processing unit 808.

Secondary memory 816 may include, for example, a same or similar type of memory as primary memory and/or one or more data storage devices or systems, such as, for example, a disk drive, an optical disc drive, a tape drive, a solid state memory drive, etc. In certain implementations, secondary memory 816 may be operatively receptive of, or otherwise configurable to couple to, a computer-readable medium 818. Computer-readable medium 818 may include, for example, any medium that can carry and/or make accessible data, code and/or instructions for one or more of the devices in system 800.

Second device 804 may include, for example, a communication interface 820 that may provide for or otherwise support the operative coupling of second device 804 to at least network 806. By way of example but not limitation, communication interface 820 may include a network interface device or card, a modem, a router, a switch, a transceiver, and the like.

Second device 804 may include, for example, an input/output 822. Input/output 822 may represent one or more devices or features that may be configurable to accept or otherwise introduce human and/or machine inputs, and/or one or more devices or features that may be configurable to deliver or otherwise provide for human and/or machine outputs. By way of example but not limitation, input/output device 822 may include a display, speaker, keyboard, mouse, trackball, touch screen, data port, and the like.

Thus, as illustrated in the various example implementations and techniques presented herein, in accordance with certain aspects a method may be provided for use as part of a special purpose computing device and/or other like machine that accesses digital signals from memory and processes such digital signals to establish transformed digital signals which may then be stored in memory as part of one or more data files and/or a database specifying and/or otherwise associated with an index.

Some portions of the detailed description have been presented in terms of processes and/or symbolic representations of operations on data bits or binary digital signals stored within memory, such as memory within a computing system and/or other like computing device. These process descriptions and/or representations are techniques used by those of ordinary skill in data processing arts to convey the substance of their work to others skilled in the art. A process is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining”, “allocating”, “establishing”, “accessing”, and/or the like refer to the actions and/or processes of a computing platform, such as a computer or a similar electronic computing device (including a special purpose computing device), that manipulates and/or transforms data represented as physical electronic and/or magnetic quantities within a computing platform's memories, registers, and/or other information (data) storage device(s), transmission device(s), and/or display device(s).

According to an implementation, one or more portions of an apparatus, such as second device 804, for example, may store one or more binary digital electronic signals representative of information expressed as a particular state of a device, here, second device 804. For example, an electronic binary digital signal representative of information may be “stored” in a portion of memory 810 by affecting or changing a state of particular memory locations, for example, to represent information as binary digital electronic signals in the form of ones or zeros. As such, in a particular implementation of an apparatus, such a change of state of a portion of a memory within a device, such a state of particular memory locations, for example, to store a binary digital electronic signal representative of information constitutes a transformation of a physical thing, here, for example, memory device 810, to a different state or thing.

While certain exemplary techniques have been described and shown herein using various methods and systems, it should be understood by those skilled in the art that various other modifications may be made, and equivalents may be substituted, without departing from claimed subject matter.

Additionally, many modifications may be made to adapt a particular situation to the teachings of claimed subject matter without departing from a central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
extracting a plurality of objects and a plurality of facets from a first set of external corpora, wherein the first set of external corpora comprises an extraction corpus;
transforming first data from a second set of external corpora into second data having a common data format, wherein the second set of external corpora comprises ranking corpora;
ranking the facets based at least upon the second data;
mapping a query to one or more of the objects to obtain one or more query objects; and
retrieving a ranked list of facets for the one or more query objects.

2. The method of claim 1, wherein ranking the facets comprises:
statistically analyzing second data derived from the ranking corpora to obtain a plurality of corpus rankings for each one of the facets; and
calculating an overall ranking for each one of the facets based at least in part on the corpus rankings for each one of the facets.

3. The method of claim 2, wherein statistically analyzing the second data comprises performing a co-occurrence analysis using the second data.

4. The method of claim 3, wherein calculating the overall ranking for each one of the facets comprises linearly aggregating the corpus rankings to derive the overall ranking for each facet.

5. The method of claim 4, wherein linearly aggregating the corpus rankings comprises computing a conditional probability scores for each facet using each of said external ranking sources.

6. The method of claim 5, wherein linearly aggregating the corpus rankings further comprises weighting the overall ranking for each facet such that a ranking corpus having an event space that comprises query terms is used to derive most of the overall ranking for each facet.

7. The method of claim 2, further comprising:
storing a first set of binary electronic signals, the first set of binary electronic signals representative of at least the overall ranking of the facets; and
transmitting a second set of binary electronic signals in response to the query, the second set of binary electronic signals representative of the ranked list of facets.

8. An article comprising:
a storage medium comprising machine-readable instructions stored thereon which are executable by a special purpose computing apparatus to:
extract a plurality of objects and a plurality of facets from a first set of external corpora, the first set of external corpora comprising an extraction corpus;
transform first data from a second set of external corpora into second data having a common data format, wherein the second set of external corpora comprises ranking corpora;
rank the facets based at least upon the second data;
map a query to one or more of said objects to obtain one or more query objects; and
retrieve a ranked list of facets for said one or more query objects.

9. The article of claim 8, wherein ranking the facets comprises performing a statistical analysis on a first ranking corpus having an event space that comprises query terms to obtain a first metric for the facets.

10. The article of claim 9, wherein ranking the facets comprises performing a statistical analysis on a second ranking corpus having an event space that comprises query sessions to obtain a second metric for the facets.

11. The article of claim 10, wherein ranking the facets comprises performing a statistical analysis on a third ranking corpus having an event space that comprises image files populating a user-searchable image database and tags associated with the image files to obtain a third metric for the facets.

12. The article of claim 11, wherein ranking the facets comprises calculating an overall ranking for the facets using a linear combination of the first metric, the second metric, and the third metric.

13. The article of claim 12, wherein in the linear combination the first metric is weighted more heavily than the third metric, and the third metric is weighted more heavily than the second metric.

14. The article of claim 13, wherein the first, second, and third metrics comprise a conditional user probability that is defined as a number of users who have used both a source object and a target object in an event, divided by a number of users who have used the source object in an event.

15. The article of claim 13, wherein the first, second, and third metrics comprise one selected from a group consisting of a joint user probability and a point-wise mutual information metric.

16. An apparatus comprising:
a computing platform comprising:
a communication interface to receive from an electronic communication network one or more electrical digital signals transmitting information; and
one or more processors to:
extract a plurality of objects and a plurality of facets from a first set of external corpora, the first set of external corpora comprising an extraction corpus;
transform first data from a second set of external corpora into second data having a common data format, wherein the second set of external corpora comprises ranking corpora;
rank said facets based at least upon the second data;
map a query in one or more signals received from the communication interface to one or more of said objects to obtain one or more query objects; and
retrieve a ranked list of facets for said one or more query objects.

17. The apparatus of claim 16, wherein said one or more processors are further programmed to transmit first binary digital signals representative of said ranked list of facets to a user device via said communication interface.

18. The apparatus of claim 17, wherein said one or more processors are further programmed to display on said user device said ranked list of facets based on said first binary digital signals.

19. The apparatus of claim 18, where said one or more processors are further programmed to:
statistically analyze second data derived from the ranking corpora to obtain a plurality of corpus rankings for each one of the facets; and
calculate an overall ranking for each one of the facets based at least in part on the corpus rankings for each one of the facets.

20. The apparatus of claim 19, wherein said one or more processors are further programmed to rank facets by deriving a linear combination of at least two metrics, each of said at least two metrics corresponding to one of said ranking corpora.
